(19) United States
(12) Patent Application Publication
(10) Pub. No.: US 2025/0208035 A1
(43) Pub. Date: Jun. 26, 2025

(54) ANALYZER WITH A LOW-MAINTENANCE LIGHT SOURCE ASSEMBLY

(71) Applicant: Endress+Hauser Conducta GmbH+Co. KG, Gerlingen (DE)

(72) Inventors: Guido Mennicken, Leonberg (DE); Frank Rüdiger, Haigerloch (DE)

(21) Appl. No.: 18/990,237

(22) Filed: Dec. 20, 2024

(30) Foreign Application Priority Data
Dec. 21, 2023 (DE) 10 2023 136 203.8

(51) Int. Cl. G01N 21/33; G01N 21/25

(52) U.S. Cl. CPC G01N 21/33; G01N 21/255; G01N 2201/062

(57) ABSTRACT

An analyzer containing: a chamber containing an interior space which during operation is filled with a liquid containing an analyte, wherein the chamber has a liquid passageway between the first and the second wall; a light source assembly irradiating the interior of the chamber with UV light; a measuring detector which detects the light from the light source assembly via the liquid passageway and which is arranged opposite the second wall and is connected to a device that measures and evaluates the light intensity, wherein the light source assembly comprises at least two light sources, which are each arranged at 1 mm to 1 m from the first wall of the chamber, wherein the measuring and evaluating device includes a control system which is designed to keep constant the UV radiation intensity of the light sources acting on the liquid.

### CROSS-REFERENCE TO RELATED APPLICATION

The present application is related to and claims the priority benefit of German Patent Application No. 10 2023 136 203.8, filed on Dec. 21, 2023, the entire contents of which are incorporated herein by reference.

### TECHNICAL FIELD

The present disclosure relates to an analyzer comprising a low-maintenance light source assembly, as well as a method for analyzing analytes by means of the low-maintenance light source assembly.

### BACKGROUND

Analyzers based on absorption of an analyte in the infrared (IR) to UV range can be used to measure concentrations of analytes.

Such analytes can be, for example, organic molecules, such as proteins, nucleic acids, sugars, the sum of the dissolved organic ingredients in an aqueous sample, as well as inorganic cations and anions, for example nitrates, or gases.

Most analyzers for detecting analytes or substances that absorb in the ultraviolet (UV) range use a mercury lamp, deuterium lamp, or xenon flash lamp as a light source. Such instruments contain cuvettes or flow cells in which a solution containing one or more UV-absorbing substances is passed between a UV light source (e.g., a mercury lamp) and a UV detector (e.g., a photomultiplier tube or photodiode), and changes in the intensity of the UV light reaching the detector are related to the concentration of the UV-absorbing substances in the solution.

LEDs are increasingly being used in analyzers because they are small compared to mercury lamps and allow for more compact installation. However, LEDs also have disadvantages. UV LEDs, in particular, show a decreasing intensity over longer periods of operation. At the end of the lamp's lifespan, a sudden, complete failure often occurs. The decreasing intensity of the light source has negative impacts on the measuring range, accuracy and detection limit of the measuring device. Due to the failure of the light sources, replacement of the light sources and therefore maintenance is necessary.

### SUMMARY

The object of the present disclosure is to provide a light source assembly which extends the maintenance intervals of the analyzer significantly, i.e., by a multiple of the maintenance intervals from half a year to one year, and which makes it possible to maintain a stable light intensity of the analyzer over the entire product life cycle and thus to achieve a constant measurement performance.

The object is achieved by the analyzer 1 according to the present disclosure containing:
a chamber 2 containing an interior space 3, which during operation is filled with a liquid containing an analyte 4 to be measured, wherein the chamber 2 has a liquid passageway 7 between a first 5 and a second wall 6;
a light source assembly 8 irradiating the interior of the chamber with UV light;
a measuring detector with at least one sensor 9, which detects the light from the light source assembly 8 via the liquid passageway 7 and which is arranged opposite the second wall and is connected to a device 10 which measures and evaluates the light intensity,
wherein, the light source assembly 8 comprises at least two light sources 11.1-11.2, for example at least three light sources 11.1-11.3, which are each arranged at a distance of 1 mm to 1 m from the first wall 5 of the chamber,
wherein the measuring and evaluating device 10 comprises a control which is designed to keep constant the UV radiation intensity of the at least two, for example at least three, light sources acting on the flowing liquid over the entire cross section of the measuring chamber, wherein
the light sources are, for example, LEDs.

The light source assembly according to the present disclosure provides an analyzer which has a plurality of light sources which can be operated simultaneously at a reduced power or can be switched one after the other, thereby significantly reducing the maintenance effort of the light source assembly.

Compared to the state of the art, the maintenance intervals are increased by at least a factor of 2 or at least a factor of 3, for example the maintenance intervals are increased by a factor of 3 to 10.

In at least one embodiment of the analyzer, the path length of each of the at least two light sources 11.1-11.2, for example at least three light sources (11.1-11.3) is between 1 mm and 50 mm or 0.5 to 1.5 m.

In one embodiment of the analyzer, the at least two light sources 11.1-11.2, for example at least three light sources 11.1-11.3, are arranged on an arc 12 which is concave relative to the longitudinal axis L of the chamber 2 or on a line parallel to the longitudinal axis L of the chamber.

In at least one embodiment of the analyzer, the arc 12 is preferably arranged on a plane perpendicular or parallel to the longitudinal axis of the chamber L.

In at least one embodiment of the analyzer, the chamber 2 is:
a flow chamber containing an inlet and an outlet; or
is designed as a cuvette.

In at least one embodiment of the analyzer, a beam splitter 13, for example a semi-transparent mirror, is located in the beam path between each of the at least two light sources 11.1-11.2, for example at least three light sources (11.1-11.3) and the chamber 2, wherein the beam splitter 13, for example, a semi-transparent mirror, is designed to:
guide a first part of the radiation of selected light sources 11.1-11.7 through the measuring sample to the measuring detector 9; and
guide a second portion of the radiation from selected light sources 11.1-11.7 to a reference detector 14, which is designed to measure the incident radiation to determine the radiation intensity,
wherein when the beam intensity falls below a predefined level, the applied power to the LEDs is adjusted via the control system.

An adjustment of the applied power occurs when the light intensity falls below 0.5%, preferably when the light intensity falls below 0.5-1%.

In at least one embodiment of the analyzer, at least two light sources, for example at least three up to all light sources or 2-32, or 3-32, or 2-16, or 3-16 light sources are switched on simultaneously.

In at least one embodiment of the analyzer, 2 to 16, preferably 3 to 16, light sources, preferably LEDs, are switched on simultaneously.

In at least one embodiment of the analyzer, the at least two light sources, for example at least three light sources, for example LEDs, are in a wavelength range between 220 nm and 950 nm, wherein the at least two, preferably at least three, light sources have a uniform wavelength.

In at least one embodiment of the analyzer, the at least two light sources, for example at least three light sources, for example LEDs, have a wavelength of 270 to 280 nm, for example, 265 nm.

In at least one embodiment of the analyzer, the at least two light sources for example at least three light sources, for example LEDs, have a wavelength of 463 nm, 527 nm, 590 nm, 621 nm, 840 nm, 850 nm, 875 nm, 880 nm, 885 nm, 890 nm, 940 nm or 950 nm.

In at least one embodiment of the analyzer, the temperature of the liquid to be analyzed is between −20° C. and 15° C.

In at least one embodiment of the analyzer, the temperature of the liquid to be analyzed is more than 0-8° C. or 100-150° C.

Aqueous liquids can be used at temperatures between 0 and 8° C. and up to 100° C. At higher temperatures, the liquids are oils, such as mineral oils, or vegetable fats, such as palm oil.

The present disclosure also relates to a method for analyzing a measured variable in a measuring fluid, wherein the method comprises:
providing an analyzer according to the present disclosure or an embodiment thereof comprising at least two light sources 11.1-11.2, for example at least three light sources 11.1-11.3
measuring the light intensity of the radiation incident on the reference detector 14 and on the measuring detector 9, wherein the measuring electrode detects the radiation after path length which comprises the chamber 2 containing one or more reference solutions and then the measuring solution or solutions,
wherein the light intensity of the at least two light sources 11.1-11.2, for example two to 16 light sources or 3 to 16 light sources or of all light sources of the light source assembly 8 is determined simultaneously,
wherein the light intensity is kept constant by continuously determining the radiation that is incident on the reference detector 14, transmitting it to the control system and, if a predefined radiation intensity is not reached, adjusting the applied power to the LEDs via the control system. The light sources, which are designed as LEDs, typically comprise at least one electronic semiconductor component which emits light when current flows through it. The light sources as described in this present disclosure are designed as multi-LED chips and thus consist of a plurality of individual semiconductor elements (LEDs).

Both the measuring detector and the reference detector can be designed as a diode or as a photomultiplier.

### BRIEF DESCRIPTION OF THE DRAWINGS

FIG. 1 shows an embodiment of the analyzer according to the present disclosure.

### DETAILED DESCRIPTION

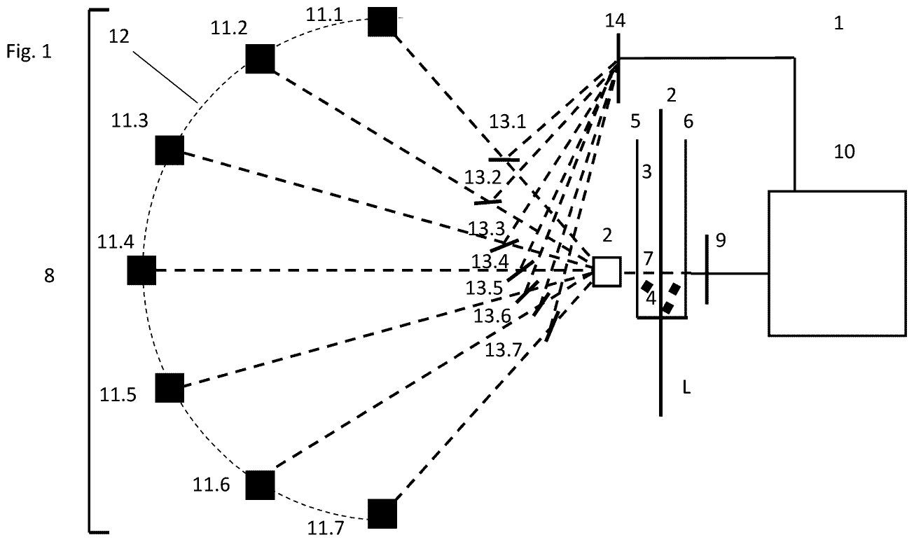

FIG. 1 shows an embodiment of the analyzer according to the present disclosure with seven light sources 11.1-11.7 and a chamber 2 which is designed as a cuvette. These light sources will either be switched on simultaneously or they will be switched on symmetrically one after the other. In addition to the measurement with the measuring detector 9, the light intensity is measured with a reference detector 14, which measures the light intensity independent of the analyte and forwards it to the control of the evaluation device 10: a beam splitter 13.1-13.7, for example a semi-transparent mirror, is arranged in the beam path between each light source and the chamber, whereby a first part of the radiation from the selected light source is guided through the measurement sample to the measuring detector 9 and a second part of the radiation from the particular light source is guided to the reference detector 14. By controlling the evaluation device 10, the intensity of the radiation sources is adjusted via the applied power to the LEDs in such a way that a constant light intensity is incident on the chamber 2 and the sample therein.

First, measurements are carried out with reference samples to calibrate the device. After the use of reference samples, they are removed from the cuvette 2 by a suction process. Before the subsequent measurement process, the cuvette is rinsed once or a plurality of times with either water or a suitable cleaning solution. A flow cell is rinsed with a suitable cleaning solution, such as water, before samples containing an analyte to be measured are introduced into the chamber.

All embodiments of the analyzer described above can be combined with one another and with the analysis method, provided this is technically possible.

Reference signs are not to be understood as a limitation of the scope of the subject matter protected by the claims. They serve only the purpose of making the claims easier to understand.

1. An analyzer comprising:
a chamber containing an interior space, which is filled during operation with a flowing liquid containing an analyte to be measured, wherein the chamber includes a liquid passageway between a first and a second wall;
a light source assembly irradiating the interior space of the chamber with UV light;
a measuring detector, which detects light from the light source assembly via the liquid passageway and is arranged opposite the second wall and is connected to a device which measures and evaluates the light intensity,
wherein the light source assembly comprises at least two light sources,
wherein the measuring and evaluating device comprises a control system which is designed to keep constant the UV radiation intensity of the at least two, light sources acting on the flowing liquid over an entire cross section of the chamber,
wherein the at least two light sources are LEDs.

2. The analyzer according to claim 1, wherein the path length of each of the at least two light sources is between 1 and 50 mm or 0.5 to 1.5 m.

3. The analyzer according to claim 1, wherein the at least two light sources are arranged on an arc which is concave with respect to the longitudinal axis of the chamber or on a line parallel to the longitudinal axis of the chamber.

4. The analyzer according to claim 3, wherein the arc is arranged on a plane perpendicular or parallel to the longitudinal axis of the chamber.

5. The analyzer according to claim 1, wherein the chamber is designed as:
a flow chamber containing an inlet and an outlet; or
a cuvette.

6. The analyzer according to claim 1, wherein a beam splitter is located in a beam path between each of the at least two light sources and the chamber, wherein the beam splitter is designed to:
guide a first part of the radiation of the at least two up to all light sources through the measuring sample to the measuring detector; and
guide a second part of the radiation of the at least two up to all light sources to a reference detector, which is designed to measure incident radiation to determine radiation intensity, wherein when a beam intensity falls below a predefined level, an applied power to the at least two light sources is adjusted via the control system.

7. The analyzer according to any of claim 1, wherein up to all of the at least two light sources are switched on simultaneously.

8. The analyzer according to claim 1, wherein up to half of the at least two light sources are switched on simultaneously.

9. The analyzer according to claim 1, wherein the at least two light sources are in a wavelength range between 220 nm and 950 nm and emit radiation with a uniform wavelength.

10. The analyzer according to claim 9, wherein the at least two light sources emit a wavelength of 270 to 280 nm.

11. The analyzer according to claim 9, wherein the at least two light sources emit a wavelength of 463 nm, 527 nm, 590 nm, 621 nm, 840 nm, 850 nm, 875 nm, 880 nm, 885 nm, 890 nm, 940 nm or 950 nm.

12. The analyzer according to claim 1, wherein the temperature of the liquid to be analyzed is between −20° C. and 150° C.

13. The analyzer according to claim 11, wherein the temperature of the liquid to be analyzed is more than 0-8° C. or 100-150° C.

14. A method for analyzing a measured variable in a measuring liquid, wherein the method comprises:
providing an analyzer according to claim 6;
measuring a light intensity of the incident radiation on the reference detector and on the measuring detector,
wherein the measuring detector detects the incident radiation after traversing a path length which includes the chamber containing one or more reference solutions and then the measuring liquid,
wherein the light intensity of up to all of the at least two light sources is determined simultaneously,
wherein the light intensity is kept constant by continuously determining the radiation that is incident on the reference detector, transmitting it to the control system and, if a predefined radiation intensity is not reached, adjusting the applied power to the LEDs via the control system.

15. The analyzer according to claim 1, wherein the at least two light sources are each arranged at a distance of 1 mm to 1 m from the first wall of the chamber.

16. The analyzer according to claim 1, wherein the light source assembly comprises at least three light sources.

17. The analyzer according to claim 6, wherein the beam splitter comprises a semi-transparent mirror.

18. The analyzer according to claim 9, wherein the at least two light sources emit a wavelength of 275 nm.
